(19) United States
(12) Patent Application Publication
(10) Pub. No.: US 2023/0316309 A1
(43) Pub. Date: Oct. 5, 2023

(54) SYSTEM AND METHOD FOR TARGETING DIGITAL CONTENT AT PRODUCT TERMINALS USING REFERENCE DATA

(71) Applicant: NewsBreak Media Networks, Inc., Knoxville, TN (US)

(72) Inventors: Brian C. Nelson, Knoxville, TN (US); Christopher Thompson, Knoxville, TN (US)

(21) Appl. No.: 18/207,769

(22) Filed: Jun. 9, 2023

Related U.S. Application Data
(63) Continuation-in-part of application No. 18/108,606, filed on Feb. 11, 2023.
Application No. 18/108,606 is a continuation of application No. 15/782,246, filed on Oct. 12, 2017, now Pat. No. 11,580,565.
(60) Provisional application No. 62/407,711, filed on Oct. 13, 2016.

(51) Int. Cl. G06Q 30/0204; G06Q 30/0242; G06Q 30/0251; G06N 20/00

(52) U.S. Cl. CPC G06Q 30/0205; G06Q 30/0246; G06Q 30/0269; G06Q 30/0259; G06Q 30/0244; G06N 20/00

(57) ABSTRACT

A targeted advertising scheduling and displaying process in the context of product terminal displays is made possible by systems and methods as disclosed herein. A graphical user interface (GUI) allows a content provider to select digital content and display timing instructions, which the associated server will ultimately send to a server associated with the product terminal displays by first sending data that references the digital content and includes the display timing instructions, and then sending the digital content itself in response to the execution of the data at the server associated with the product terminal displays. Using this claimed technique and system, a content provider can target digital content to particular product terminal displays.

### CROSS-REFERENCES TO RELATED APPLICATIONS

This application is a continuation-in-part of application Ser. No. 18/108,606, filed on Feb. 11, 2023, which is a divisional of application Ser. No. 15/782,246, filed on Oct. 12, 2017, which claims benefit of U.S. Provisional Patent Application No. 62/407,711, filed Oct. 13, 2016, and which is hereby incorporated by reference.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND

Entities, such as corporations, government offices, retailers, etc., often place terminals that include displays at various locations. These terminals can facilitate self-service transactions. For example, the terminals may be located at self-service gas pumps, electric chargers, self-service ATMs, airports, hotels, restaurants, etc. The terminals may also serve as product terminals that output digital content, including advertisements for products.

Entities often struggle to identify and output digital content that target specific people or groups of people at product terminals (such as self-service gas pumps, electric chargers, self-service ATMs, etc.), or the product terminals themselves, with the ultimate goal of converting single product purchasers to multi-product customers. The single product terminals present unique technical challenges. They generally have smaller storage and processor capacity, are separated from point-of-sale terminals for other products, and have varying configurations with regards to other product terminals, such as being organized around a centralized product terminal server. These particular technical limitations present problems, which the claimed inventions address through the methods and systems described herein.

A major problem for the convenience store industry is the number of customers who drive in, access a single-product terminal (for example, fuel up at a self-service gas pump), and then drive away. While this self-service model is expedient and convenient for customers, it has posed a problem for convenience store owners who earn the majority of their profits on higher margin items sold inside the convenience store. Because the interaction time and space with such a customer is limited, convenience stores find it difficult to convey marketing messages to customers to alert them to deals, products, and services in which they might be interested. In fact, a majority of convenience store customers never set foot inside the convenience store despite convenience stores spending millions of dollars on in-store improvements to incentivize walk-ins. Without being able to market higher margin, in-store sales to a majority of customers, convenience stores struggle with profitability and split energies between commodity gasoline pricing and convenience store pricing.

Furthermore, convenience stores can differ significantly with regard to geographic variables like location, proximity to highway, accessibility, average household income for the area, average demographic segmentation, etc. Moreover, different convenience stores are subject to variable conditions such as time, weather, and temperature, which dramatically affect sales. Accordingly, there is not a one-size-fits-all approach regarding marketing and advertising. There is a benefit to displaying certain media at one convenience store while displaying other media at another convenience store, or to displaying the same or different media at all similarly situated convenience stores.

Many stores have attempted to incentivize walk-ins through at-terminal, personalized (to a person, group of people, or similarly situated terminal) advertising. However, displays at such terminals pose a number of technical obstacles that make it a challenge to display a particular advertisement at a particular time. One common method to address these issues is to use the “pull” approach, whereby data is pulled by the terminal displays (or associated hardware). But this “pull” method does not allow for the content provider to control the flow of content, as it must rely on the terminal display to pull the content. In this method, the content provider cannot decide that it wants to display a certain piece of digital content and then immediately display it on the terminal displays. It must wait for the terminal display to request any new media, which it might only do daily.

Another option is a “push” method, whereby the content provider pushes data to the product terminal display. This method generally does not work for the technical restraints of such a terminal, because the connections to many product terminals have low socket bandwidth. Additionally, terminal computing hardware often has low internet connectivity and storage, both for individual terminals and for servers associated with groups of terminals. Accordingly, stores cannot presently efficiently display particular content to a terminal of its choosing at a time of its choosing due to these technological limitations. The claim methods and systems use a combination push and pull system to overcome these challenges.

### BRIEF SUMMARY

Various embodiments are disclosed herein regarding a fully integrated merchandising solution that has the ability to manage and deliver content through a centralized, automated content management administrator.

In accordance with one aspect of a system and method as disclosed herein, an integrated, programmatic merchandising platform for the retail industry is comprised of at least three components: (1) screens (including pump-top or integrated screens and in-store television monitors) for display of audiovisual content; (2) a digital signage computer at each location with multi-channel output capabilities for delivering content to each monitor (which may be associated with a single screen or with multiple screens and may be located remote from any screen or attached to or integrated with a screen(s)); and (3) a network operations center (including a server) to operate and distribute content across the retailer location network.

An embodiment of a software platform as disclosed herein makes possible the transmission, display, and general control of media content on product terminal displays from a remote, centralized system. Generally, within this system, scheduled digital content is displayed on product terminal displays according to preset playlists, AI-powered decisions, and network-wide decisions. This proprietary platform provides a content provider the ability to also target individual terminal product displays or groups of individual terminal product displays. It does this through the use of small pieces of data that it can push to the servers associated with the product terminal displays, which then causes the servers associated with the product terminal displays to pull the full digital content. In this way, the system gets the benefits of both the push system (e.g., content provider control) and the pull system (e.g., small amounts of data sent from the remote server).

### BRIEF DESCRIPTION OF THE SEVERAL VIEWS OF THE DRAWINGS

FIG. 1 is a block diagram representing an embodiment of a programmatic merchandising system as disclosed herein.

FIG. 2 is a flowchart representing various steps in at least one embodiment of a method as disclosed herein.

FIG. 3 is an example computer system for implementing various embodiments described herein.

### DETAILED DESCRIPTION

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

Depending on the embodiment, certain acts, events, or functions of any of the algorithms described herein can be performed in a different sequence, can be added, merged, or left out altogether (e.g., not all described acts or events are necessary for the practice of the algorithm) Moreover, in certain embodiments, acts or events can be performed concurrently, e.g., through multi-threaded processing, interrupt processing, or multiple processors or processor cores or on other parallel architectures, rather than sequentially.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable medium known in the art. An exemplary computer-readable medium can be coupled to the processor such that the processor can read information from, and write information to, the memory/storage medium. In the alternative, the medium can be integral to the processor. The processor and the medium can reside in an ASIC. The ASIC can reside in a user terminal. In the alternative, the processor and the medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The term “communications network” as used herein with respect to data communication between two or more parties or otherwise between communications network interfaces associated with two or more parties may refer to any one of, or a combination of any two or more of, telecommunications networks (whether wired, wireless, cellular or the like), a global network such as the Internet, local networks, network links, Internet Service Providers (ISP's), and intermediate communication interfaces.

The term “display timing instructions” as used herein may refer to computer code or other data that dictates the order or timing of display. For example, a content provider could dictate, via the display timing instructions, that the relevant digital content should be displayed immediately, as soon as it is received by the product terminal. For another example, a content provider could dictate, via the display timing instructions, that the relevant digital content should be displayed after the current digital content is displayed. For yet another example, a content provider could dictate, via the display timing instructions, that the digital content should be placed at the end of the current media playlist (such as a queue of media arranged in the order it is currently to be displayed) and displayed after the contents in the current playlist are displayed.

As indicated above, conventional systems prevent stores from displaying a targeted advertising to a screen (such as a screen at a pump) of its choosing at a time of its choosing. Embodiments described herein address the technological limitations by providing a merchandising platform that enables product terminal advertising effective to convert product terminal customers to in-store customers, with a verification component that provides convenience stores with business intelligence reporting as to effectiveness by tracking and estimating the conversion rate from product terminal purchases to in-store purchases. In an embodiment, a programmatic merchandising platform for the retail industry comprises three components: (1) screens (including pump-top or integrated screens and in-store television monitors) for display of audiovisual content; (2) a digital signage computer at each location with multi-channel output capabilities for delivering content to each monitor (which may be associated with a single screen or with multiple screens and may be located remote from any screen or attached to or integrated with a screen(s)); and (3) a network operations center (including a server) to operate and distribute content across the retailer location network.

An embodiment described herein allows the specific targeting of digital content by sending only small reference data initially. As such, embodiments described herein address the above-referenced limitations of conventional systems by providing an architecture and process by which the content provider can control the display and timing of digital content.

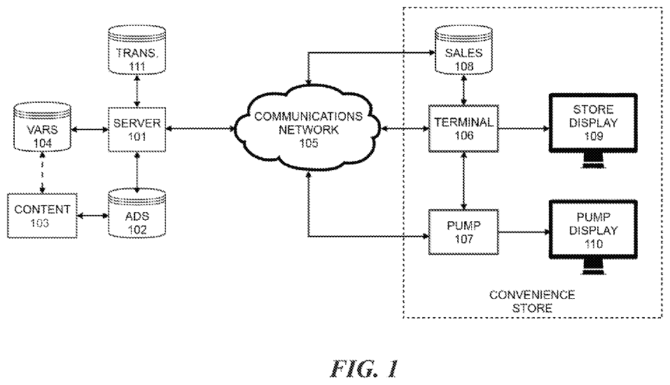

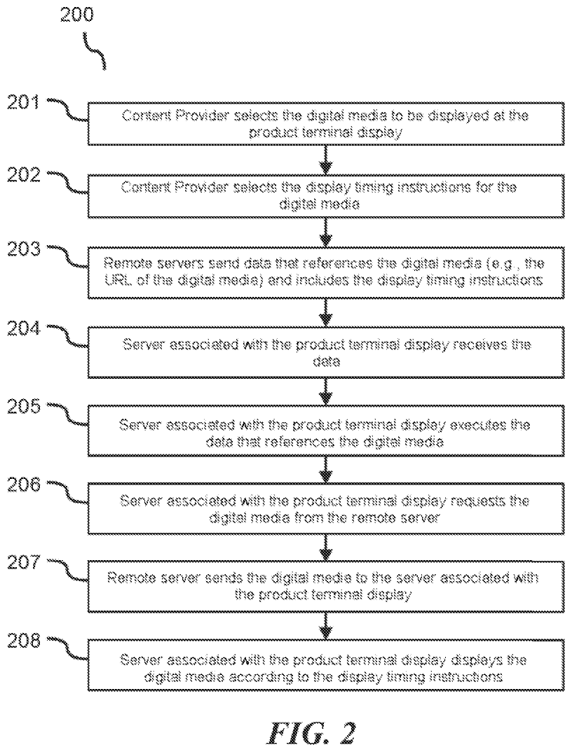

Referring generally to FIGS. 1-2, various exemplary embodiments may now be described in detail for a programmatic merchandising system and one or more embodiments of methods thereto for targeting digital content at product terminals using small reference data. Where the various figures may describe embodiments sharing various common elements and features with other embodiments, similar elements and features may be given the same reference numerals, and redundant description thereof may be omitted below.

Referring first to FIG. 1, an exemplary embodiment of a programmatic merchandising system 100 as disclosed herein may include an advertising server 101 for managing and delivering advertising content. The advertising content may be stored on an advertising database 102 communicatively connected thereto. The advertising database may host a plurality of data including multimedia advertising content 103. The multimedia advertising content 103 may be associated by server 101 with one or more specific products or services to be advertised and sold at client convenience stores. For example, the multimedia advertising content 103 may include formatted, audiovisual advertisements for videographic display advertising in-store products such as food products, drink products, automotive products, alcohol, tobacco products, and the like.

Server 101 may further be connected to a key consumer variables database 104 upon which key consumer variables are stored in association with one or more client convenience stores. Each client convenience store may be associated by server 101 with a plurality of key consumer variables for tracking sales performance and conditions related to sales performance for each client convenience store location. In an embodiment, key consumer variables may be aggregated or grouped and further stored upon the key consumer variable database 104 in relation to a plurality of client convenience stores, such as by geographical region, by client, or by other type. For example, key consumer variables may exist for each client convenient store, for stores within a certain county, for stores within a certain state, for all stores of a certain client brand, for all independently owned stores, for all 24/7 stores, etc.

Server 101 is connected via a communications network 105 to at least one convenience store, wherein server 101 may be communicatively connected to an in-store POS terminal 106, an on-site gas pump terminal 107 (the product terminal), and a convenience store sales database 108, wherein sales data for POS terminal 106 and gas pump terminal 107 are stored. The sales database 108 may in various embodiments be stored offsite in relation to the client convenience store, to which the relation of the sales database 108 to the store terminals are logical and communicative, such as via the communications network 105. For example, a convenience store brand may store and aggregate sales data for multiple associated convenience store locations. Server 101 may be communicatively connected to this sales data via an API to extract sales data in relation to individual stores and various terminals therein. Multiple terminals are contemplated herein, wherein additional terminals function in accordance with their respective type (e.g., a pump terminal 107 or an in-store POS 106).

Server 101 may determine for a given convenience store a preliminary set of advertising content 103 to be delivered via the communications network 105 and displayed on-site. The system 101 may determine the preliminary set based on associated static key consumer variables determined from the variable database 104 including, at minimum, products sold by the client convenience store. For example, server 101 may determine that a convenience store only sells Coca-Cola products and thereby excludes advertisements pertaining to Pepsi products; or server 101 may determine from a preprogrammed association or from algorithms based on historical data analysis that umbrella advertisements generate more sales at stores in rainy areas and, therefore, selects related advertisements. Server 101 may further refine the preliminary set and determine a subset of ads to deliver based on dynamic key consumer variables. For example, server 101 may select advertisements for items which perform better given certain weather or time conditions: breakfast items in the morning; hot coffee on cold days; tire chains when snow is imminent; etc. Server 101 may continually redefine the set of advertisements primed to deliver based upon the changing of these dynamic key consumer variables.

In one embodiment, server 101 may deliver a series of selected advertisements for display at the convenience store via video screens. For example, server 101 may continuously stream or may deliver for caching and periodic playback one or more advertisements for display, such as upon an in-store display 109. Server 101 may also or alternatively deliver advertisements on demand, such as when a customer initiates a transaction at pump terminal 107. In one embodiment, server 101 may determine one or more advertisements to play based upon the selected set. In another embodiment, server 101 may determine an advertisement from additional client POS data. For example, server 101 may curate specific advertisements based on the time of the transaction, the type of fuel selected, the quality of fuel selected, the amount of fuel purchased in the transaction, the customer loyalty number entered (or lack thereof), the type of credit card, the credit card number, etc. This curation may be statically programmed, such as if the system has been programmed to select certain advertisements for customers who select premium gas or pay using an American Express card, or the curation may be dynamically determined from historical sales figures, such as if server 101 determines that advertisements for extra-large fountain drinks perform better with customers who purchase over 25 gallons of fuel in a transaction. Server 101 may transmit the targeted advertisement for display on a pump-based display screen 110. In certain embodiments, such as when targeted curation is not possible or feasible, server 101 may select an advertisement from the previously curated ads for display on the pump-based display screen 110.

In one embodiment, server 101 may, in real-time or in historical review, access and analyze the sales data from the sales database 108 and determine sales trends therefrom pertaining to item sales and transactional trends. Server 101 may further heuristically aggregate transactions based upon times following advertisement display on the one or more displays 109 and 110. For example, server 101 may identify a sale of two 24-oz. Coca-Cola products via an in-store terminal and associate that sale with a previous transaction from pump terminal 107 wherein a video was displayed for a customer on display 110 advertised two 24-oz. Coca-Cola products for the price of one during an at-pump transaction that occurred less than 300 seconds prior. The product sale and at-pump transaction may be associatively linked via direct evidence data, e.g., the same credit card, same customer loyalty number used, or use of a coupon code via the advertisement; or via extrinsic evidence data, such as time between transactions, differential from normal product sales patterns, etc.

Server 101 may store variable data and algorithms pertaining to the sales transactions in a transaction database 111 on an ongoing basis and determine therefrom via historical pattern analysis, trend differentiation, machine learning algorithms, and other similar automated methods whether certain advertisements are effective at creating sales conversions. In an embodiment, server 101 may analyze any direct evidence data or indirect evidence data to determine whether an advertisement was the likely or proximate cause for causing a customer to engage in purchasing behavior. For example, server 101 may identify an upswing in food product sales and determine that 80% of said sales can be attributed to food product advertisements displayed directly to a customer.

Server 101 may adjust the content selection and curation algorithms, or variables thereof, in response to determinations made as to effectiveness of advertisements over a period of time. Continuing the above example, server 101 may significantly increase the likelihood that food product advertisements will be displayed due to the high, 80% response rate, thereby ensuring that a food product advertisement is more likely to display than a less effective advertisement. Server 101 may further make this determination on a store-by-store basis, such as where certain stores have an 80% response rate, but other stores only have an 8% response rate. In further embodiments, server 101 may attribute differences in response rates to differences in key consumer variables and adjust the advertisement selection algorithms or variables thereof to maximize conversion for a plurality of stores based on the key consumer variables. For example, where four convenience stores have seen a 27% increase in in-store follow-up sales following display of an advertisement for energy drinks on rainy days, the system may increase the likelihood of energy drink advertisements for other stores in different geographic locations where rain is projected to occur, despite the absence of pertinent sales data for those particular stores.

In an embodiment, server 101 may further store customer profiles in association with client loyalty programs, credit card number, or another unique identifier. In an embodiment, server 101 may store the customer profiles in a customer profile database. Server 101 may determine advertisements that are more or less effective for a particular user in accordance with predetermined or analyzed customer metrics. Specifically, this customer profile may be maintained across multiple client convenience stores, such that advertisements deemed more likely to engage a specific customer in a product sale and convert the customer from a pump transaction to an in-store follow-up purchase will be displayed. For example, where server 101 would normally send for display on pump display 110 an advertisement for beer products, but server 101 has determined a unique customer from sales data from the sales database 108 and profiled said customer as never having historically purchased a beer product, server 101 may override the original determination for display of a beer ad and substitute an advertisement for an alternative product.

In certain embodiments, the system may further deliver advertisements to a customer mobile device, such as where a customer uses his or her mobile device for a customer loyalty program. Such an embodiment may be advantageous for uniquely identifying and tracking conversion rates. For example, an ad may display either on the user device or on a pump display 110, whereby a coupon QR code may be sent to the user's mobile device to be scanned at the store terminal 106 upon purchase of the advertised products to redeem a discount.

In another embodiment, a content provider can select display timing instructions (either selecting explicitly or selecting the default through inaction), after which server 101 may generate and display timing instructions for displaying advertising content 103 on store display 103 or on pump display 110. Server 101 may transmit data referencing advertising content 103 and the assigned display timing instructions to a server at either Terminal 106 or Pump 107, either of which are associated with the client retail location, over communications network 105. The data can, for example, be a Uniform resource Locator (URL) of the content 103. The server at either terminal 106 or pump 107 executes the data to request the referenced content 103. For example, the server creates a GET request for the URL specified in the data to retrieve the content 103. Thus, in response to execution of the data referencing advertising content 103 and the assigned display timing instructions, server 101 may send advertising content 103 to the server at Terminal 106 or Pump 107 causing display of advertising content 103 based on the display timing instructions. In particular, server 101 may transmit instructions to the server at either Terminal 106 or Pump 107 which causes display of advertising content 103 at pump display 110 according to display timing instructions. The display timing instructions dictate the timing of displaying advertising content 103 at pump display 110. For example, display timing instructions may indicate the length of displaying advertising content 103, when to start displaying advertising content 103, when to stop displaying advertising content, etc. And the display timing instructions may do so in reference to the actual time, the current playlist of content to be played at the pump display 110, or the current content playing at the pump display 110. As a non-limiting example, display timing instructions may indicate that advertising content 103 is displayed immediately after the display of any other advertising content that is currently displayed on pump display 110. A user may assign default instructions for the display timing instructions at server 101. In this regard, all or part of the display timing instructions may be predetermined or preset default instructions. Finally, assigning display timing instructions can also comprise receiving playback timing instructions from the content provider, where the timing instructions are a particular rule or rules that dictate when the content 103 should be played, such as a rule stating that the content 103 should be played every thirty minutes, and assigning said received playback timing instructions as the display timing instruction.

The server at terminal 106 or pump 107 may be communicatively connected to terminals that are exterior to the client retail location, including pump terminal 107. The server at terminal 106 or pump 107 may send advertising content 103 to the terminals exterior to the client retail location, including pump terminal 107. To this end, the server at terminal 106 or pump 107 may also transmit data referencing advertising content 103 and the display timing instructions to pump terminal 107.

In some embodiments, advertising content 103 and display timing instructions received by the servers at terminal 106 or pump 107 may be cached at that server in cache and/or non-persistent memory. For example, advertising content 103 can be cached at the servers at terminal 106 before it transmits advertising content 103 to pump terminal 107.

In some embodiments, as discussed above, server 101 is associated with, and may render, a graphical user interface (GUI) through which the content provider may provide or select certain information. For example, the content provider can select the display timing instructions, the content 103, and/or the method of transmission.

In some embodiments, pump display 110 may also render a graphical user interface (GUI). Pump display 110 may render information about advertising content 103. For example, the information may include but is not limited to a thumbnail, link, image, description, etc. The GUI may receive a selection of advertising content 103 for display at pump display 110. The selection may be an input with respect to the information rendered on the GUI using one or more input devices and/or human digits.

The data may also include a reference to pump display 110 and/or pump terminal 107. The reference indicates that advertising content 103 is to be displayed at pump display 110. In response to execution of the data referencing advertising content 103 and display timing instructions, server 101 causes advertising content 103 to be displayed at pump display 110 according the display timing instructions.

In certain embodiments, as noted above, server 101 may receive a selection of advertising content 103 for display at on pump display 110. Pump display 110 may be located at terminal 106. In varying embodiments, Terminal 106 may be a server or set of servers that are connected to multiple Pumps 107 and Pump Displays 110, and not a POS terminal. In those cases, the Server 101 can communicate with Terminal 106, which is in turn communicates to the Pumps 107 and Pump Displays 110. Terminal 106 may also be located outside a client retail location. Alternatively, in other embodiments, each Pump 107 can itself have a server or set of servers, which communicate to the Pump Display 110. Finally, Content 103 may be associated with one or more products or services sold at POS terminal 106 inside the client retail location.

FIG. 2 is a flowchart illustrating a process for targeting digital content at product terminals using small reference data as disclosed herein may be described in part or in whole as follows. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously, or in a different order than shown in FIG. 2, as will be understood by a person of ordinary skill in the art.

In step 201, the advertising system allows a content provider to select the digital content to be displayed at the product terminal display.

In step 202, the content provider also selects the display timing instructions for the digital content. In various embodiments, this can be accomplished in many ways, for example by explicitly inputting the desired timing, or by not inputting an explicit timing and thus electing a default timing. The remote server accessible by the content provider associates the selected display timing instructions with the digital content.

In step 203, the remote servers send data that references the digital content to the server associated with the product terminal display. That data can be any smaller data that allows for future retrieval of the digital content such as, for example, the URL of the digital content. The server associated with the product terminal display can be a single server or can be multiple servers, and it can be a part of the product terminal display, the product terminal, or it can be separate from the product terminal. Further, the server can be associated with only a single product terminal and product terminal display, or it can be associated with multiple product terminals and product terminal displays prod. Finally, in step 203, the data sent by the remote servers also includes the display timing instructions.

In step 204, the server associated with the product terminal display receives the data (including the reference to the digital content and the display timing instructions) from the remote server.

In step 205, the server associated with the product terminal display executes the data that references the digital media. This can take a variety of forms. For example, if the data is the URL of the digital content, then the execution of the data can take the form of creating and sending a GET request to the URL to retrieve the digital content.

In step 206, the server associated with the product terminal display requests the digital content from the remote server. Again, this can take a variety of forms. In the example discussed above, the server associated with the product terminal display can use a GET request sent to the remote server to request the digital content from the remote server.

In step 207, the remote server sends the digital media to the server associated with the product terminal display. Continuing the example from above, the remote server sends the digital content in a GET response to the server associated with the product terminal display. As discussed above, this innovation allows the system to have the benefits of a push system and a pull system. The remote server needs only send (“push”) a small amount of data (the data referencing the digital content), which it can do even within the technical limitations of the product terminal system. And then the server associated with the product terminal display can request (“pull”) the digital content, while still allowing the remote server (and thereby the content provider) to control its display. To be clear, the digital content need not necessarily be limited to advertising or to the product being advertised.

In step 208, the server associated with the product terminal display displays the digital media according to the display timing instructions. For example, the server associated with the product terminal display, after receiving the digital content, can display the display content after the currently displayed digital content has finished being displayed. For another example, the display timing instructions could indicate that the digital content should be placed at the end of a current playlist so that it is displayed after the digital content currently in the playlist is finished being displayed.

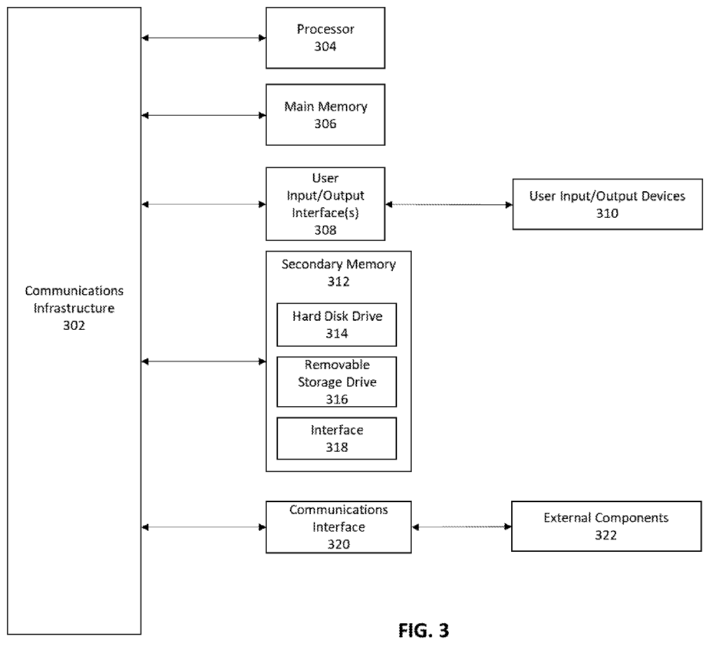

FIG. 3 is a block diagram of a computer system 300 for implementing various embodiments. Computer system 300 can be used, for example, to implement method 200 of FIG. 2. Furthermore, computer system 300 can be at least part of one or more components of programmatic merchandising system 100, as shown in FIG. 1. Computer system 300 can be any computer capable of performing the functions described herein.

Computer system 300 may include one or more processors (also called central processing units, or CPUs), such as a processor 304. Processor 304 may be connected to a communication infrastructure or bus 302.

Computer system 300 may also include user input/output device(s) 310, such as monitors, keyboards, pointing devices, etc., which may communicate with communication infrastructure 306 through user input/output interface(s) 308.

One or more of processors 304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 may also include a main or primary memory 308, such as random access memory (RAM). Main memory 306 may include one or more levels of cache. Main memory 306 may have stored therein control logic (i.e., computer software) and/or data.

Computer system 300 may also include one or more secondary storage devices or memory 312. Secondary memory 310 may include, for example, a hard disk drive 314, a removable storage device or drive 316, or interface 318. Removeable storage device or drive 316 and interface 318 may be coupled to storage devices such as external hard drives, USB flash drives, SD cards, Compact Discs, etc.

Computer system 300 may further include a communication or network interface 320. Communication interface 320 may allow computer system 300 to communicate and interact with any combination of external components 324, such as external devices, external networks, external entities, etc. For example, communication interface 302 may allow computer system 300 to communicate with external components 322 over a communications path, which may be wired and/or wireless (or a combination thereof), and which may include any combination of LANs, WANs, the Internet, etc. Control logic and/or data may be transmitted to and from computer system 300 via the communication path.

Computer system 300 may be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 300, main memory 306, secondary memory 312, as well as tangible articles of manufacture embodying any combination of the foregoing. Such control logic, when executed by one or more data processing devices (such as computer system 300), may cause such data processing devices to operate as described herein.

The previous detailed description has been provided for the purposes of illustration and description. Thus, although there have been described particular embodiments of a new and useful invention, it is not intended that such references be construed as limitations upon the scope of this invention except as set forth in the following claims.

What is claimed is:

1. A method for displaying digital content at product terminals, comprising:
receiving, at a first set of servers, the selection of digital content for display at a display device of product terminals located at a first area of a client retail location;
wherein the first set of servers is not located at the client retail location;
wherein said digital content is associated with products or services sold at a transaction terminal located at a second area of the client retail location;
receiving, at the first set of servers, display timing instructions for said digital content to be displayed at the product terminal display device;
sending, to a second set of servers associated with the client retail location, data referencing said digital content and including said display timing instructions;
responsive to execution of said data at the second set of servers, sending, from the first set of servers, said digital content to the second set of servers, thereby causing said digital content to be displayed at the product terminal display device according to said display timing instructions.

2. The method of claim 1, wherein sending said digital content to the second set of servers further comprises sending the digital content such that it can be cached at the second set of servers or the product terminal display devices.

3. The method of claim 1, wherein the second set of servers is connected to a plurality of product terminal display devices via a communications network, through which the second set of servers can send the digital content to the product terminal display devices.

4. The method of claim 3, wherein said data further references a set of product terminal display devices, wherein the set is made up of one or more of said product terminal display devices.

5. The method of claim 4, wherein sending said digital content to the second set of servers further comprises sending said digital content such that it can be cached at the second set of servers before being sent to the product terminal display devices.

6. The method of claim 1, wherein the second set of servers associated with the client retail locations is a part of a product terminal.

7. The method of claim 1, wherein said display timing instructions dictate that said digital content is displayed at a particular time.

8. The method of claim 1, wherein said display timing instructions dictates that said digital content is displayed immediately after the display of any digital content that is currently displayed on the display devices.

9. The method of claim 1, wherein the received display timing instructions are default playback timing instructions.

10. The method of claim 1, wherein receiving display timing instructions comprises receiving playback timing instructions and assigning said received playback timing instructions.

11. A content management system for managing and delivering digital content, comprising:
a memory;
a processor coupled to the memory, wherein the processor is configured to:
render a graphical user interface providing the ability to:
select digital content for display at display devices of a product terminal located at a first area of a client retail location, wherein said digital content is associated with specific products or services sold at a transaction terminal located at a second area of the client retail locations;
select display timing instructions for said digital content to be displayed at the display devices;
a first set of servers remote from the retail locations and associated with the graphical user interface, said first set of servers capable of:
sending to a second set of servers associated with the client retail locations data referencing the digital content and including said display timing instructions;
responsive to execution of said data by the second set of servers, sending said digital content to said second set of servers, thereby causing said digital content to be displayed at the product terminal display devices according to said display timing instructions.

12. The system of claim 11, wherein sending said digital content to the second set of servers further comprises sending the digital content such that it can be cached at the second set of servers or the product terminal display devices.

13. The system of claim 11, wherein the second set of servers is connected to a plurality of product terminal display devices via a communications network, through which the second set of servers can send the digital content to the product terminal display devices.

14. The system of claim 13, wherein said data further references a set of product terminal display devices, wherein the set is made up of one or more of said product terminal display devices.

15. The system of claim 14, wherein sending said digital content to the second set of servers further comprises sending said digital content such that it can be cached at the second set of servers before being sent to the product terminal display devices.

16. The system of claim 11, wherein the second set of servers associated with the client retail locations is a part of a product terminal.

17. The system of claim 11, wherein said display timing instructions dictate that said digital content is displayed at a particular time.

18. The system of claim 11, wherein said display timing instructions dictates that said digital content is displayed immediately after the display of any digital content that is currently displayed on the display devices.

19. The system of claim 11, wherein said display timing instructions are default playback timing instructions.

20. The system of claim 11, wherein selecting display timing instructions comprise selecting playback timing instructions.
